(19) United States
(12) Patent Application Publication
(10) Pub. No.: US 2009/0227358 A1
(43) Pub. Date: Sep. 10, 2009

(54) Slot Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/137,104

(22) Filed: Jun. 11, 2008

Related U.S. Application Data
(60) Provisional application No. 61/034,690, filed on Mar. 7, 2008.

(51) Int. Cl. A63F 9/24; A63F 13/08; A63F 13/00

(52) U.S. Cl. 463/21; 463/31; 463/43

(57) ABSTRACT

A slot machine which: reads, from among the symbol image data stored in the memory, two symbol image data including symbol image data that may be combined with each other on condition that the side-BET is input; reduces the read symbol image data so that the two symbol images are displayed in a region for displaying a single symbol; generates combined symbol image data based on the reduced symbol image data; rearranges the generated combined symbol in the first display region and rearranges symbols corresponding to the plural types of symbol image data in the second display region; changes scaling ratios of the symbol image data so that area ratios of respective symbol images of the combined symbol are changed according to the number of times in executing the basic games; and selectively executes one bonus game from among a plurality of bonus games according to types of the combination of the combined symbol displayed in the first display region and the single symbols displayed in the second display region.

### CROSS-REFERENCE TO RELATED APPLICATIONS

This application claims priority of U.S. Provisional Application No. 61/034,690 filed on Mar. 7, 2008. The contents of this application are incorporated herein by reference in their entirety.

### BACKGROUND OF THE INVENTION

1. Field of the Invention

The present invention relates to a slot machine.

2. Description of the Related Art

Conventionally, slot machines known as a type of gaming machines are constituted so as to: start games by players inserting coins or the like into the gaming machine; variably display columns of symbols in predetermined regions of the gaming machine while they are displayed in a stopped state after a predetermined period has elapsed; and award payout based on a combination of symbols in a stopped state.

In addition, the above slot machines are generally constituted to judge whether or not a winning combination allowed to award payout is established, based on whether or not a predetermined number of symbols of the same type (for example, “CHERRY” or “7”) are arranged along a preset payline. In the conventional slot machine, in a case where a predetermined number or more of symbols of the same type are arranged, it has been a common routine to award payout based on the number of the aforementioned arranged symbols, regardless of the payout line.

Further, many of the conventional slot machines have been known which conduct two types of games, i.e., a basic game and a free game. The basic game is executed upon consumption of gaming values (such as coins or credits) corresponding to the amount of bet. On the other hand, the free game is executed without consuming gaming values corresponding to the amount of bet.

The basic game is switched to the free game when a predetermined condition is met. The condition includes a case in which, for example, a specific symbol is displayed in a stopped state during the basic game. The free game is switched to the basic game when a predetermined condition is met. The condition includes a case in which, for example, the free games are executed a predetermined number of times.

In the conventional slot machines, it has been a common routine to raise players' feeling of expectation for the free game by changing arrangement of symbols during the free game differently from that during the basic game. For example, U.S. Pat. No. 6,394,902-B1 describes a slot machine in which a total of fifteen symbols are displayed in three rows and five columns with the use of video reels. This conventional slot machine changes symbol columns arranged on reels during the free game differently from that during the basic game, in which eight types of symbols are decreased to five. In this manner, a probability of awarding payout can be apparently increased during the free game.

In the aforementioned conventional slot machines, however, irrespective of whichever of the basic game and the free game is in progress, the symbols of different types have been randomly arranged in combination and sequential order. These slot machines determine the contents of the prize to be awarded, based on a combination of multiple symbols that have been arranged in a display device. Therefore, players are allowed to have the feeling of expectation only for random payout based on a combination of plural types of symbols that have been randomly arranged in the display device. Accordingly, a need exists for the advent of a slot machine which can offer new entertainability.

The present invention has been made in view of the above-described circumstance. It is an object of the present invention to provide a novel slot machine by enhancing entertainability associated with arrangement of the symbols.

### SUMMARY OF THE INVENTION

A first aspect of the present invention is a slot machine including: a display device for displaying a symbol matrix display region having a first display region and a second display region; an input device for accepting an input of a normal BET and that of a side-BET different from the normal BET; a memory for storing plural types of symbol image data; and a controller for controlling the display device and the input device, the controller being programmed to: (a) execute a basic game; (b) read, from among the symbol image data stored in the memory, at least two symbol image data including symbol image data that may be combined with each other on condition that the side-BET is input, during the basic game, reduce a horizontal or vertical direction of the read symbol image data so that said at least two symbol images are displayed in a region for displaying a single symbol, generate, based on the reduced symbol image data, combined symbol image data for displaying a combined symbol to be displayed in the first display region; (c) rearrange the combined symbol combined corresponding to the combined symbol image data in the first display region within the symbol display region and rearrange symbols corresponding to the plural types of symbol image data in the second display region within the symbol display region, during the basic game; (d) generate the combined symbol image data obtained by changing scaling ratios of the symbol image data so that area ratios of respective symbol images of the combined symbol are changed according to the number of times in executing the basic games, and rearrange the combined symbol in the first display region according to the changed combined symbol image data; and (e) selectively execute one bonus game from among a plurality of bonus games according to types of the combination, in a case where a combination of the combined symbol displayed in the first display region and single symbols displayed in the second display region matches a predetermined combination.

According to the first aspect of the present invention, the area ratios of the respective symbol images of the combined symbol change according to the number of times in executing the basic games and according to the combination of the changed combined symbol and the single symbols, the bones game is executed. Thus, a bonus game with a high level of expectation can be realized according to the combination of the combined symbol and the single symbols. This enhances the entertainability associated with rearrangement of the symbols.

A second aspect of the present invention is a slot machine constituted as set forth below. In the first aspect, the controller, in the itemized (d), gradually changes the area ratios of the respective symbol images of the combined symbol according to the number of times in executing the basic games to transform the combined symbol into the single symbols, thereby rearranging the single symbols based on the combined symbol in the first display region, and the controller, in the itemized (e), selectively executes one bonus game from among a plurality of bonus games according to types of the combination, in a case where a combination of the single symbols transformed from the combined symbol displayed in the first display region and the single symbols displayed in the second display region matches a predetermined combination.

According to the second aspect of the present invention, the area ratios of the respective symbol images of the combined symbol gradually change according to the number of times in executing the basic games to transform the combined symbol into single symbols, thereby executing the bonus game according to the combination of the combined symbol and the single symbols transformed from the combined symbol. Thus, a bonus game with a high level of expectation can be realized according to the combination of the combined symbol and the single symbols transformed from the combined symbol. This enhances the entertainability associated with rearrangement of the symbols.

A third aspect of the present invention is a slot machine constituted as set forth below. In the first aspect, a memory for cumulatively storing a progressive value is further included, in which the controller, in the itemized (b), reads the symbol image data from the memory with referring to the progressive value of the memory so that one jackpot symbol from among the plurality of jackpot symbols is added to the combined symbol in response to a jackpot becoming a predetermined progressive value.

According to the third aspect of the present invention, when a predetermined progressive value is obtained, the jackpot symbol is added to the combined symbol, the area ratios of the respective symbol images of the combined symbol gradually change according to the number of times in executing the basic games to transform the combined symbol into the single symbols. Then, according to the combination of the combined symbol and the single symbols transformed from the combined symbol, the jackpot bonus game is executed. Thus, a bonus game with a high level of expectation can be realized according to the combination of the combined symbol and the single symbols transformed from the combined symbol. This enhances the entertainability associated with rearrangement of the symbols.

A fourth aspect of the present invention is a slot machine including: a display device for displaying a symbol matrix display region having a first display region and a second display region; an input device for accepting an input of a normal BET and that of a side-BET different from the normal BET; a memory for storing plural types of symbol image data; and a controller for controlling the display device and the input device, the controller being programmed to: (a) execute a basic game; (b) read, from among the symbol image data stored in the memory, at least two symbol image data including symbol image data that may be combined with each other on condition that the side-BET is input, during the basic game, reduce a horizontal direction or a vertical direction of the read symbol image data so that said at least two symbol images are displayed in a region for displaying a single symbol, generate, based on the reduced symbol image data, combined symbol image data for displaying a combined symbol to be displayed in the first display region; (c) rearrange the combined symbol combined corresponding to the combined symbol image data in the first display region within the symbol display region and rearrange symbols corresponding to the plural types of symbol image data in the second display region within the symbol display region, during the basic game; (d) gradually change area ratios of respective symbol images of the combined symbol according to the number of times in executing the basic games to transform the combined symbol into the single symbols, thereby rearranging the single symbols based on the combined symbol in the first display region, and (e) selectively execute one bonus game from among a plurality of bonus games according to types of the combination, in a case where a combination of the single symbols transformed from the combined symbol displayed in the first display region and the single symbols displayed in the second display region matches a predetermined combination.

According to the fourth aspect of the present invention, the area ratios of the respective symbol images of the combined symbol gradually change according to the number of times in executing the basic games to transform the combined symbol into the single symbols. Then, according to the combination of the symbols, the bonus game is executed. Thus, a bonus game with a high level of expectation can be realized according to the combination of the combined symbol and the single symbols transformed from the combined symbol. This enhances the entertainability associated with rearrangement of the symbols.

A fifth aspect of the present invention is a slot machine constituted as set forth below. In the fourth aspect, a memory for cumulatively storing a progressive value is further included, in which the controller, in the itemized (b), reads the symbol image data from the memory with referring to the progressive value of the memory so that one jackpot symbol from among the plurality of jackpot symbols is added to the combined symbol in response to a jackpot becoming a predetermined progressive value.

According to the fifth aspect of the present invention, upon becoming a predetermined progressive value, the jackpot symbol is added to the combined symbol, the area ratios of the respective symbol images of the combined symbol gradually change according to the number of times in executing the basic games to transform the combined symbol into the single symbols. Then, according to the combination of the combined symbol and the single symbols transformed from the combined symbol, the jackpot bonus game is executed. Thus, a bonus game with a high level of expectation can be realized according to the combination of the combined symbol and the single symbols transformed from the combined symbol. This enhances the entertainability associated with rearrangement of the symbols.

A sixth aspect of the present invention is a slot machine including: a display device for displaying a symbol matrix display region having a first display region and a second display region; an input device for accepting an input of a normal BET and that of a side-BET different from the normal BET; a memory for storing plural types of symbol image data and cumulatively storing a progressive value; a controller for controlling the display device and the input device, the controller being programmed to: (a) execute a basic game; (b) read the symbol image data from the memory with referring to the progressive value of the memory so that one jackpot symbol from among the plurality of jackpot symbols is added in response to a jackpot becoming a predetermined progressive value, out of at least two symbol image data including the symbol image data that may be combined on condition that the side-BET is input, from among the symbol image data stored in the memory, during the basic game, reduce a horizontal direction or a vertical direction of the read symbol image data so that said at least two symbol images are displayed in a region for displaying a single symbol, generate, based on the reduced symbol image data, combined symbol image data for displaying a combined symbol to be displayed in the first display region; (c) rearrange the combined symbol combined corresponding to the combined symbol image data in the first display region within the symbol display region and rearrange symbols corresponding to the plural types of symbol image data in the second display region within the symbol display region, during the basic game; (d) gradually change area ratios of respective symbol images of the combined symbol according to the number of times in executing the basic games to transform the combined symbol into the single symbols, thereby rearranging the single symbols based on the combined symbol in the first display region, and (e) selectively execute one bonus game from among a plurality of bonus games according to types of the combination, in a case where a combination of the single symbols transformed from the combined symbol displayed in the first display region and the single symbols displayed in the second display region matches a predetermined combination.

According to the sixth aspect of the present invention, upon becoming a predetermined progressive value, the jackpot symbol is added to the combined symbol, the area ratios of the respective symbol images of the combined symbol gradually change according to the number of times in executing the basic games to transform the combined symbol into the single symbols. Then, according to the combination of the combined symbol and the single symbols transformed from the combined symbol, the jackpot bonus game is executed. Thus, a bonus game with a high level of expectation can be realized according to the combination of the combined symbol and the single symbols transformed from the combined symbol. This enhances the entertainability associated with rearrangement of the symbols.

### BRIEF DESCRIPTION OF THE DRAWINGS

FIG. 1A is a view showing an exemplary symbol matrix during a basic game according to a first embodiment;

FIG. 1B is a view showing an exemplary symbol matrix during the basic game according to the first embodiment;

FIG. 1C is a view showing an exemplary symbol matrix during the basic game according to the first embodiment;

FIG. 2 is a perspective view schematically showing a frame format of a slot machine according to the first embodiment;

FIG. 3 is a block diagram depicting an internal construction of the slot machine shown in FIG. 2;

FIG. 4A is a view showing an exemplary image displayed in the slot machine shown in FIG. 2 according to the first embodiment during the basic game;

FIG. 4B is a view showing an exemplary image displayed in the slot machine shown in FIG. 2 during the basic game;

FIG. 5A is a view showing an exemplary image displayed in the slot machine shown in FIG. 2 during the basic game according to the first embodiment;

FIG. 5B is a view showing an exemplary image displayed in the slot machine shown in FIG. 2 during the basic game according to the first embodiment;

FIG. 6A is a view showing an exemplary image displayed in the slot machine shown in FIG. 2 during a free game according to the first embodiment;

FIG. 6B is a view showing an exemplary image displayed in the slot machine shown in FIG. 2 during the free game according to the first embodiment;

FIG. 6C is a view showing an exemplary image displayed in the slot machine shown in FIG. 2 during the free game according to the first embodiment;

FIG. 7A is a view showing an exemplary image displayed in the slot machine shown in FIG. 2 during a jackpot bonus game according to the first embodiment;

FIG. 7B is a view showing an exemplary image displayed in the slot machine shown in FIG. 2 during the jackpot bonus game according to the first embodiment;

FIG. 8A is a view showing an exemplary image displayed in the slot machine shown in FIG. 2 during the jackpot bonus game according to the first embodiment;

FIG. 8B is a view showing an exemplary image displayed in the slot machine shown in FIG. 2 during the jackpot bonus game according to the first embodiment;

FIG. 9A is a view showing an exemplary image displayed in the slot machine shown in FIG. 2 during the jackpot bonus game according to the first embodiment;

FIG. 9B is a view showing an exemplary image displayed in the slot machine shown in FIG. 2 during the jackpot bonus game according to the first embodiment;

FIG. 10 is a flowchart showing a subroutine of a main process;

FIG. 11 is a flowchart showing a subroutine of a game execution process according to the first embodiment;

FIG. 12 is a flowchart showing a subroutine of a basic game symbol rearrangement process according to the first embodiment;

FIG. 13 is a flowchart showing a subroutine of a symbol combining process according to the first embodiment;

FIG. 14 is a flowchart showing a subroutine of a free-game execution process according to the first embodiment;

FIG. 15 is a flowchart showing a subroutine of a jackpot bonus game execution process according to the first embodiment;

FIG. 16 is a view schematically depicting a frame format of an appearance of a slot machine according to a second embodiment;

FIG. 17A is a view showing an exemplary symbol matrix during a basic game according to the second embodiment;

FIG. 17B is a view showing an exemplary symbol matrix during the basic game according to the second embodiment; and

FIG. 17C is a view showing an exemplary symbol matrix during the basic game according to the second embodiment.

### DESCRIPTION OF THE PREFERRED EMBODIMENTS

First, a slot machine 10 according to a first embodiment will be described in detail with referring to the drawings. The slot machine according to the below-described first embodiment is a so-called video slot machine, which has an image display panel such as a liquid crystal display and executes a game by displaying images of various symbols on the image display panel.

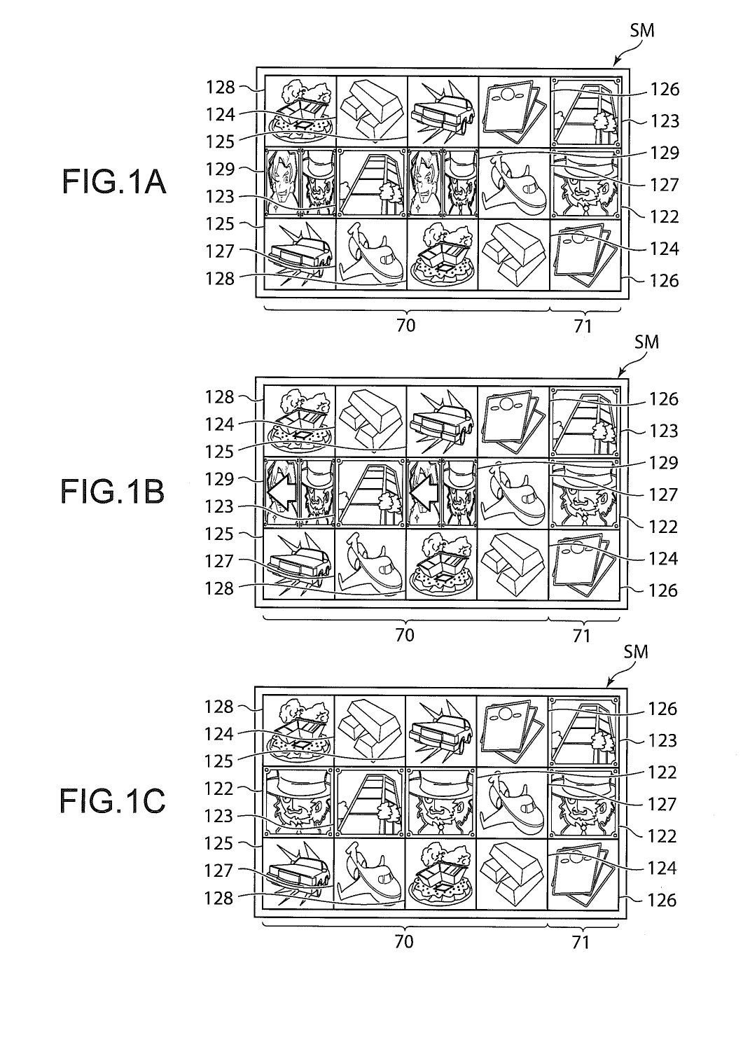

FIGS. 1A, 1B, and 1C are views each showing an exemplary symbol matrix during a basic game according to the first embodiment. The slot machine 10 according to the present invention executes any one of three modes of games, i.e., a basic game, a free game, and a progressive bonus game. The basic game is executed upon consuming a gaming value corresponding to the amount bet by a player. The free game is executed without consuming a gaming value. The progressive bonus game is executed when a predetermined progressive value is obtained. While the slot machine 10 is of a stand-alone type, which is not connected to a network, the present invention is also applicable to a networked slot machine.

As shown in FIGS. 1A, 1B, and 1C, elements of the symbol matrix SM are displayed on the lower image display panel 16 described later, included in the slot machine 10. In the elements of the symbol matrix SM, a total of fifteen symbols in three rows and five columns are rearranged.

In the first embodiment of the present invention, any of symbols “main character 121”, “sub character 122”, “office building 123”, “gold bullion 124”, “car 125”, “stock certificate 126”, “jet 127”, and “villa 128” are rearranged in the elements of symbol matrix SM. A payout is determined based on the number of symbols of respective types rearranged in the elements of the symbol matrix SM. On condition that a side-BET is input, a jackpot symbol is added to a combined symbol 129, and is rearranged.

As shown in FIG. 1A, when the predetermined progressive value is obtained during the basic game, any of the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM in a first display region 70 of the symbol matrix SM. The “combined symbol 129” is a symbol image of which the horizontal or vertical direction is reduced so that at least two symbol images are displayed in an element of the symbol matrix SM, in which a single symbol is displayed. The two symbols are combined with each other on condition that the side-BET is input. In this case, since the side-BET is input, a combination formed of two “combined symbols 129” and one “sub character 122” is rearranged. In the “combined symbol 129”, the horizontal direction of the symbols of the main character 121 and the sub character 122 or jackpot symbol is reduced. In a second display region 71, in any of the elements of the symbol matrix SM, the symbols, “main character 121”, “sub character 122”, “office building 123”, “gold bullion 124”, “car 125”, “stock certificate 126”, “jet 127”, and “villa 128” are rearranged.

As shown in FIG. 1B, in the “combined symbol 129” rearranged in the first display region 70 in FIG. 1A, area ratios of the respective symbols of the combined symbol are changed according to the number of times in executing the basic games. In this case, according to the number of times in executing the basic games, a scaling ratio in a horizontal direction between the main character 121 and the sub character 122 or jackpot symbol is changed so that the symbol of the main character 121 added to the “combined symbol 129” is rearranged more widely or the symbol of the sub character 122 or jackpot symbol is rearranged more widely. In this way, the “combined symbol 129” is changed.

As shown in FIG. 1C, after the area ratios of the respective symbols of the combined symbol are changed in FIG. 1B, according to types of the combination of the changed “combined symbol 129” rearranged in the first display region 70 and a single symbol rearranged in the second display region 71, one bonus game is selectively executed from among a plurality of bonus games. In this case, since a combination of three sub characters 122 is rearranged, the jackpot bonus game is selected and executed according to the types of the combination.

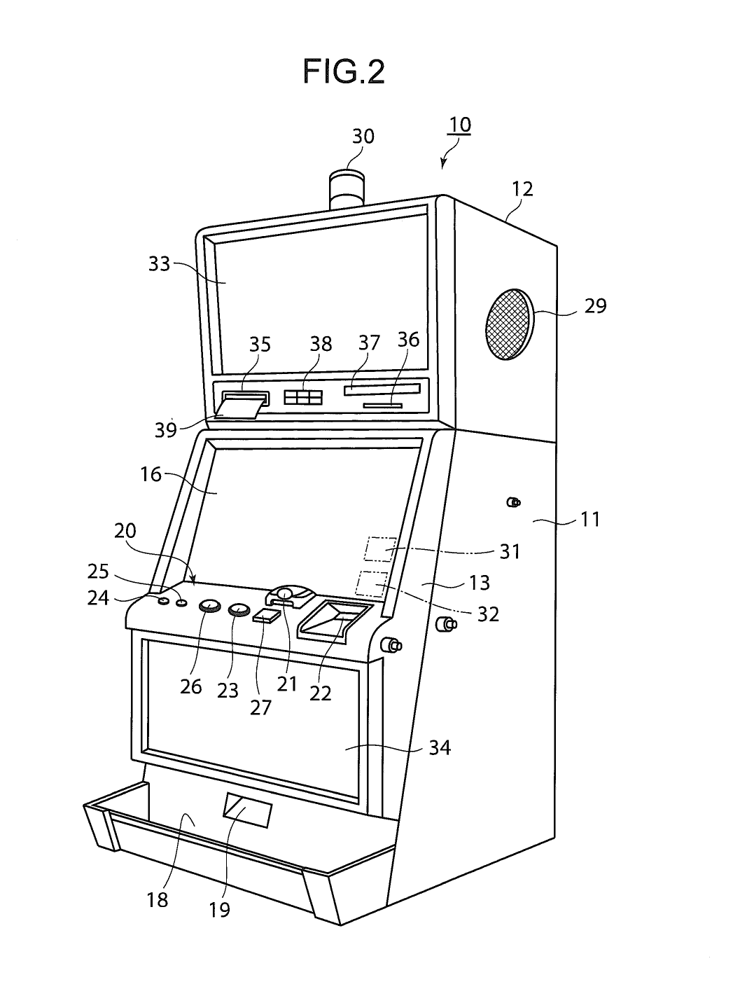

FIG. 2 is a view schematically depicting a frame format of an appearance of the slot machine according to the first embodiment of the present invention. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

The lower image display panel 16 serving as a display device is provided in front of the main door 13. The lower image display panel 16 is provided with a liquid crystal panel, which displays the fifteen elements of the symbol matrix SM in three rows and five columns. A single symbol is arranged in each of the elements of the symbol matrix SM.

A credit amount display section 31 of the lower image display panel 16 displays the number of coins credited by way of an image. A payout amount display unit 32 displays by way of an image the number of, for example, coins to be paid if a predetermined number or more symbols of respective types are rearranged in the elements of the symbol matrix SM 28.

Provided on a lower side of the lower image display panel 16 are a control panel 20 having a plurality of buttons 23 to 27 through which command regarding the process of the game will be input by a player, a coin receiving slot 21 for receiving coins into the cabinet 11, and a bill validator 22.

On the control panel 20, a start button 23, a change button 24, a cashout button 25, a 1-BET button 26, and a MAX-BET button 27 are provided. The start button 23 is intended for entering a command for starting the game. The change button 24 is intended for use in asking an attendant of the gaming facility for change. The cashout button 25 is intended for entering a command for paying out the credited coins to a coin tray 18 through a coin payout exit 19.

The 1-BET button 26 is intended for entering a command for betting one coin among the credited coins on the game. The MAX-BET button 27 is intended for entering a command for betting the upper number (50 in this embodiment) of coins that can be bet per game among the credited coins on the game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a speaker 29 and a lamp 30 are provided. On a lower side of the upper image display panel 33, a ticket printer 35, a card reader 36, a data display unit 37, and a key pad 38 are provided. The ticket printer 35 prints on the ticket, a barcode having encoded thereon data such as the credit amount, the date and time, and the identification number of the slot machine 10, and outputs the printed ticket as the barcode-attached ticket 39. The player can play the game on another slot machine with the barcode attached ticket 39 by causing this slot machine to read the barcode attached ticket 39. Alternatively, the player can exchange the barcode-attached ticket 39 with the bills or the like at a predetermined place (at a cashier inside a casino, for example) of the gaming facility.

The card reader 36 reads data from and write data into a smart card. The smart card is to be owned by the player, which stores data for identifying the player or data regarding the log of games executed by the player, for example. The smart card may store data corresponding to coins, bills, or a credit. As an alternative of a smart card, a magnetic stripe card may be employed. The data display 37 is made up of a fluorescent display and the like, and displays the data read by the card reader 36 or the data input by the player through the key pad 38, for example. The key pad 38 inputs data and commands regarding the ticket issuance or the like.

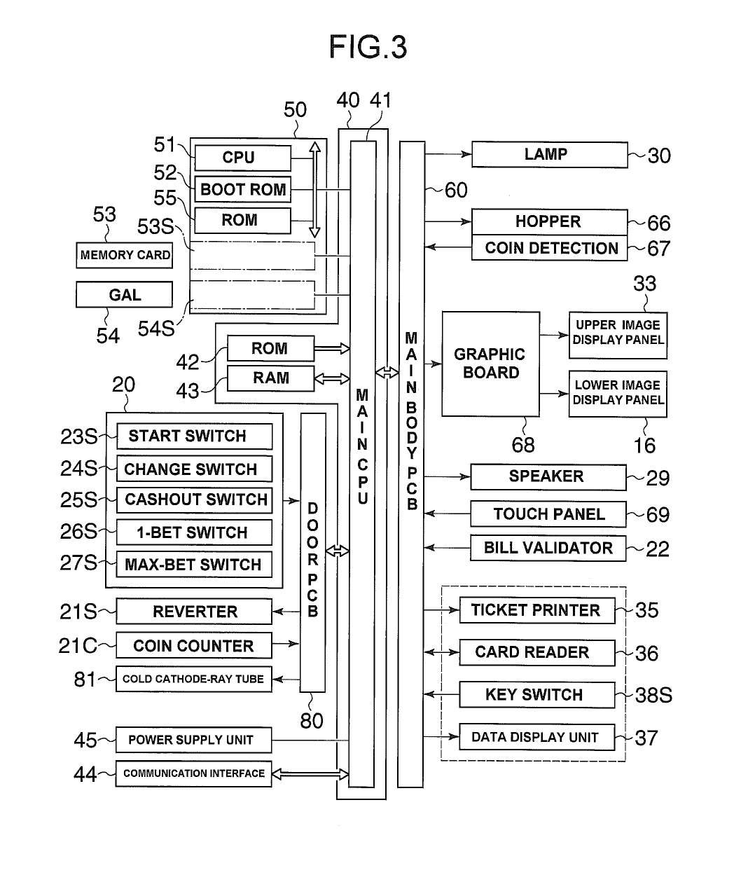

FIG. 3 is a block diagram depicting an internal construction of the slot machine shown in FIG. 2. A gaming board 50 includes: a CPU (Central Processing Unit) 51, a ROM (Read Only Memory) 55 and a boot ROM 52 interconnected by an internal bus; a card slot 53S corresponding to a memory card 53; and an IC socket 54S corresponding to a GAL (Generic Array Logic) 54.

The memory card 53 is formed of a nonvolatile memory such as Compact Flash (registered trademark) and stores game programs. The game programs include a symbol selection program. The aforementioned symbol selection program is intended for determining the symbols to be rearranged in the elements of the symbol matrix SM 28. The aforementioned symbol selection program includes symbol weighing data respectively corresponding to plural types of payout ratios (80%, 84%, and 88%, for example). The symbol weighing data is indicative of the correspondence relationship between the respective symbols and one or more random numeric values which come under a predetermined numerical range (0 to 255). The payout ratio is determined according to the payout-ratio setting data output from the GAL 54. The symbols to be rearranged in the elements of the symbol matrix SM 28 are determined depending upon the symbol weighing data corresponding to the payout ratio. Further, the game programs include table data indicating the correspondence relationship between each of the symbols and a payout.

Also, the card slot 53S is configured to allow the memory card 53 to be inserted thereinto or ejected therefrom, and is connected to a mother board 40 through an IDE pass. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game program includes programs concerning a game progress. Furthermore, the game program includes image data or sound data to be output during the game. The image data include, for example, image data indicative of the symbol matrix.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Further, the IC socket 54S is configured to allow the GAL 54 to be attached thereto and detached therefrom, and is connected to the mother board 40 by a PCI bus. Accordingly, the GAL can be replaced with the replacement GAL 54 to change the payout-ratio setting data.

The CPU 51, the ROM 55, and the boot ROM 52 interconnected by the internal bus are connected to the mother board 40 by the PCI bus. The PCI bus serves to transmit signals between the mother board 40 and the gaming board 50 and supply power from the mother board 40 to the gaming board 50.

The mother board 40 is constructed using a general-purpose mother board commercially available (a printed circuit board on which essential parts of a personal computer are mounted) and includes: a main CPU (Central Processing Unit) 41, a ROM (Read Only Memory) 42; a RAM (Random Access Memory) 43; and a communication interface 44. The main CPU 41 functions as a processor for controlling a display device and a memory according to the embodiment of the present invention.

The ROM 42 is made up of a memory device such as a flash memory and stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80, which will be described later, are connected to the mother board 40 by USB. A power supply unit 45 is also connected to the mother board 40.

Connected to the main body PCB 60 and the door PCB 80 are: equipment and devices which generate input signals to be input to the main CPU 41; and equipment and devices of which operations are controlled by a control signal output from the main CPU 41. The main CPU 41 executes a game program stored in the RAM 43 based on an input signal having been input to the main CPU 41 and performs a predetermined computational process, thereby storing results thereof in the RAM 43 or transmitting a control signal to each of equipment and devices as a control process therefore.

A lamp 30, a hopper 66, a coin detecting section 67, a graphic board 68, a speaker 29, a touch panel 69, the bill validator 22, the ticket printer 35, the card reader 36, a key switch 38S, and the data display unit 37 are connected to the main body PCB 60. The lamp 30 is lit up in a predetermined pattern based on a control signal output from the main CPU 41.

The hopper 66 is installed in the cabinet 11 and pays out a predetermined number of coins from the coin payout exit 19 to the coin tray 18 based on a control signal output from the main CPU 41. The coin detecting section 67 is installed inside the coin payout exit 19 and outputs an input signal to the main CPU 41 upon detecting that a predetermined number of coins have been paid out from the coin payout exit 19.

The graphic board 68 controls, based on a control signal output from the main CPU 41, images to be displayed on the upper image display panel 33 and the lower image display panel 16. The credit amount stored in the RAM 43 is displayed on the credit amount display section 31 (see FIG. 2) of the lower image display panel 16. The number of coins to be paid out is displayed at the payout amount display section 32 (see FIG. 2) of the lower image display panel 16. The graphic board 68 is equipped with a VDP (Video Display Processor) which generates image data based on a control signal output from the main CPU 41 and a video RAM which temporarily stores image data generated by the VDP, and the like. The image data used in generating the image data with VDP is contained in the game program read from the memory card 53 and stored in the RAM 43.

The bill validator 22 validates whether or not a bill is legitimate and accepts a legitimate bill into the cabinet 11. Upon accepting a legitimate bill, the bill validator 22 outputs an input signal to the main CPU 41 based on the amount of the bill. The main CPU 41 stores in the RAM 43 the credit amount corresponding to the amount of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as the barcode-attached ticket 39. The card reader 36 transmits to the main CPU 41 the data read from the smart card and writes the read data onto the smart card, based on a control signal from the main CPU 41. The key switch 38S is provided on the key pad 38, and outputs a predetermined input signal to the main CPU 41 when the player operates the key pad 38. The data display 37, based on a control signal output from the main CPU 41, displays the data read by the card reader 36 and the data input by the player through the key pad 38.

The control panel 20, a reverter 21S, a coin counter 21C, and a cold cathode tube 81 are connected to the door PCB 80. The control panel 20 is provided with: a start switch 23S corresponding to the start button 23; a change switch 24S corresponding to the change button 24; a cashout switch 25S corresponding to a cashout button 25; and a 1-BET switch 26S corresponding to the 1-BET button 26; a MAX-BET switch 27S corresponding to the MAX-BET button 27. When the player operates the buttons 23 to 27, the corresponding switches 23S to 27S output input-signals to the main CPU 41, respectively.

The coin counter 21C is provided inside the coin receiving slot 21, and validates whether or not a legitimate coin is inserted by the player into the coin receiving slot 21. Those other than the legitimate coins are discharged from the coin payout exit 19. The coin counter 21C outputs an input signal to the main CPU 41 when a legitimate coin is detected.

The reverter 21S operates based on a control signal output from the main CPU 41 and distributes coins recognized as being legitimate by the coin counter 21C into a cash box (not shown in the drawings) or the hopper 66 which is arranged in the slot machine 10. In other words, when the hopper 66 is filled with coins, legitimate coins are distributed by the reverter 21S into the cash box. On the other hand, when the hopper 66 is not filled with coins, legitimate coins are distributed into the hopper 66. The cold cathode tube 81 functions as a backlight installed on a rear face side of each of the lower image display panel 16 and the upper image display panel 33, and is lit up based on a control signal output from the main CPU 41.

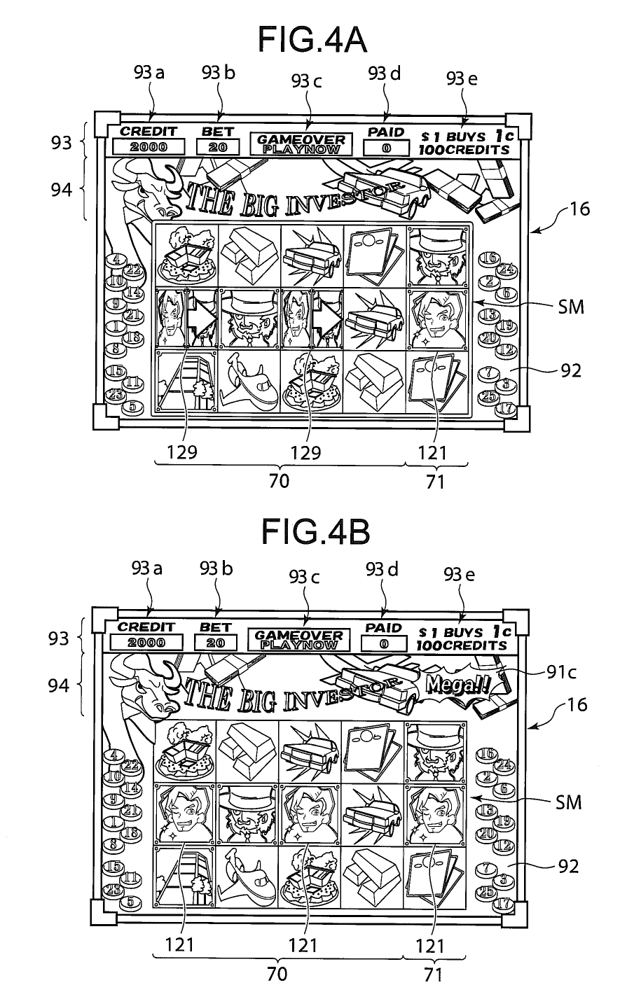

FIGS. 4A to 9B are diagrams illustrating an exemplary image displayed on the slot machine illustrated in FIG. 2 according to the first embodiment. FIGS. 4A and 4B are diagram illustrating an exemplary symbol matrix displayed on the slot machine illustrated in FIG. 2 during the basic game according to the first embodiment.

As shown in FIG. 4A, the lower image display panel 16 is made up of a display region 92, an information display section 93, an effect image display section 94, and the like. The elements of the symbol matrix SM are displayed in the display region 92. The information display section 93 is arranged upwardly of the display region 92 and is made up of a credit amount display section 93a, a BET amount display section 93b, a character information display section 93c, a PAID amount display section 93d, and a charge display section 93e.

The number of coins currently credited is displayed at the credit amount display section 93a while the number of coins bet on one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that have been successfully obtained in one game is displayed at the PAID amount display section 93d, whereas a conversion value of the credit amount based on a predetermined charge is displayed at the charge display section 93e.

The effect image display section 94 displays effect images according to a type of the present slot game. In other words, the effect image display section 94 displays different effect images between the basic and free games.

Any of symbols, “main character 121”, “sub character 122”, “office building 123”, “gold bullion 124”, “car 125”, “stock certificate 126”, “jet 127”, “villa 128”, and “combined symbol 129” are rearranged in the elements of the symbol matrix SM on the lower image display panel 16.

As shown in FIG. 4A, when the predetermined progressive value is obtained during the basic game, in the first display region 70 of the symbol matrix SM, the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM. The “combined symbol 129” is a symbol image of which the horizontal or vertical direction is reduced so that at least two symbol images are displayed in an element of the symbol matrix SM, in which a single symbol is displayed. The two symbol images are combined on condition that the side-BET is input. In this case, since the side-BET is input, a combination formed of two “combined symbols 129” and one “sub character 122” is rearranged. In the “combined symbol 129”, the horizontal direction of the symbols of the main character 121 and the sub character 122 or jackpot symbol is reduced. In the second display region 71, the symbols, “main character 121”, “sub character 122”, “office building 123”, “gold bullion 124”, “car 125”, “stock certificate 126”, “jet 127”, and “villa 128” are rearranged in any of the elements of the symbol matrix SM.

As shown in FIG. 4B, in the “combined symbol 129” rearranged in the first display region 70 in FIG. 4A, area ratios of the respective symbols of the combined symbol are changed according to the number of times in executing the basic games. In this case, according to the number of times in executing the basic games, a scaling ratio in a horizontal direction between the main character 121 and the sub character 122 or jackpot symbol is changed so that the symbol of the main character 121 added to the “combined symbol 129” is rearranged more widely or the symbol of the sub character 122 or jackpot symbol is rearranged more widely. In this way, the “combined symbol 129” is changed. Thereafter, according to types of the combination of the changed “combined symbol 129” rearranged in the first display region 70 and the single symbol rearranged in the second display region 71, one bonus game is to be selectively executed from among a plurality of bonus games. In this case, since a combination of three main characters 121 is rearranged, the free game is selected and executed according to the types of the combination.

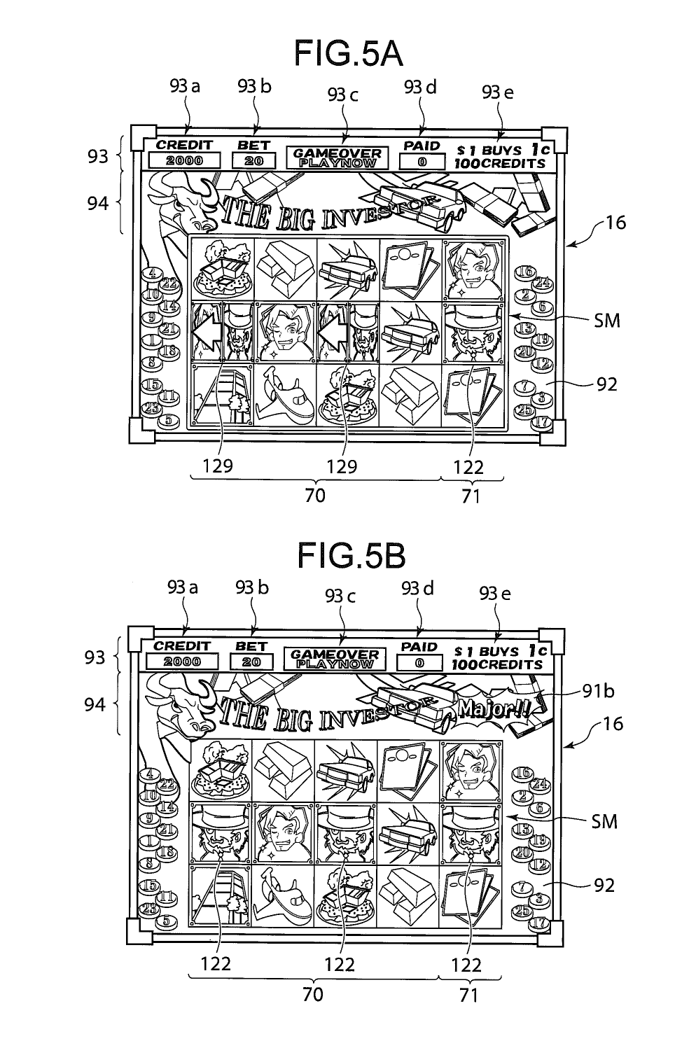

FIGS. 5A and 5B are views each showing an exemplary image displayed in the slot machine shown in FIG. 2 during the basic game according to the first embodiment. When a predetermined progressive value is obtained during the basic game, in the first display region 70 of the symbol matrix SM, the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM. The “combined symbol 129” is a symbol image of which the horizontal or vertical direction is reduced so that at least two symbol images are displayed in an element of the symbol matrix SM, in which a single symbol is displayed. The two symbol images are combined on condition that the side-BET is input. In this case, since the side-BET is input, a combination formed of two “combined symbols 129” and one “main character 121” is rearranged. In the “combined symbol 129”, the horizontal direction of the symbols of the main character 121 and the sub character 122 or jackpot symbol is reduced. In the second display region 71, in any of the elements of the symbol matrix SM, the symbols, “main character 121”, “sub character 122”, “office building 123”, “gold bullion 124”, “car 125”, “stock certificate 126”, “jet 127”, and “villa 128” are rearranged.

As shown in FIG. 5B, in the “combined symbol 129” rearranged in the first display region 70 in FIG. 5A, area ratios of the respective symbols of the combined symbol are changed according to the number of times in executing the basic games. In this case, according to the number of times in executing the basic games, a scaling ratio in a horizontal direction between the main character 121 and the sub character 122 or jackpot symbol is changed so that the symbol of the main character 121 added to the “combined symbol 129” is rearranged more widely or the symbol of the sub character 122 or jackpot symbol is rearranged more widely. In this way, the “combined symbol 129” is changed. Thereafter, according to types of the combination of the changed “combined symbols 129” rearranged in the first display region 70 and the single symbol rearranged in the second display region 71, one bonus game is selectively executed from among a plurality of bonus games. In this case, since a combination of three sub characters 122 is rearranged, the jackpot bonus game is selected and executed according to the types of the combination.

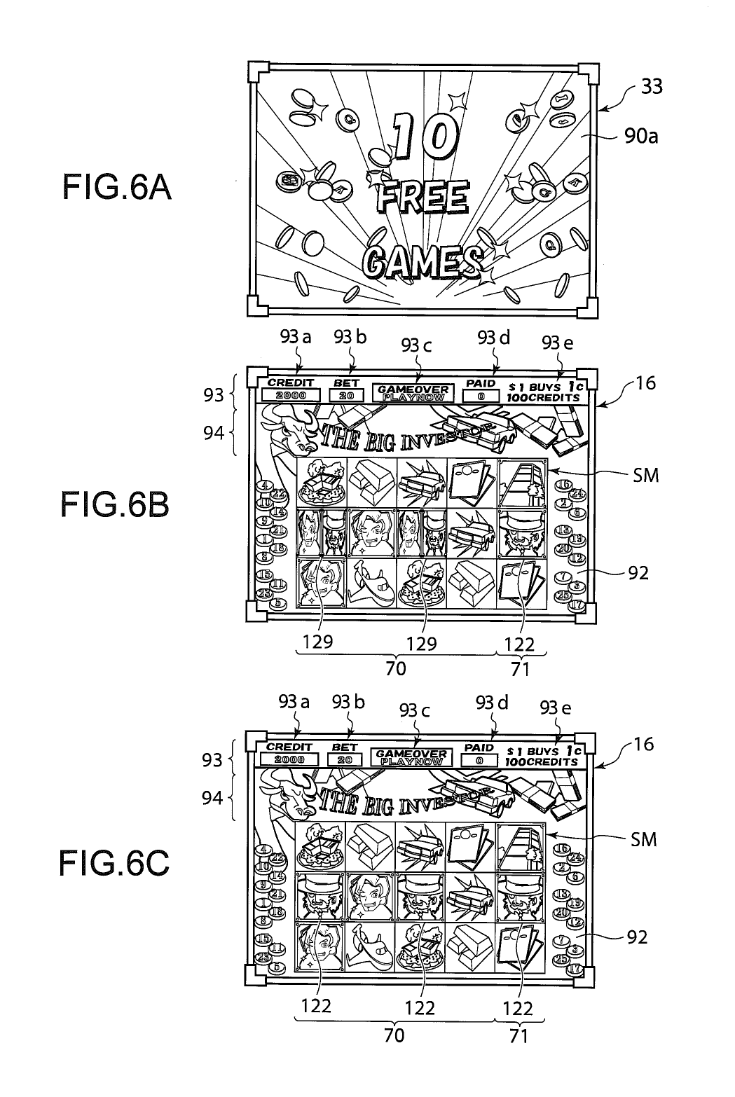

FIGS. 6A and 6B are diagrams each illustrating an exemplary image displayed in the slot machine 10 shown in FIG. 2 during the free game according to the first embodiment. As shown in FIG. 6A, when the symbols rearranged in the elements of the symbol matrix SM in FIG. 4B form a combination for executing the free game, the free game is started. Upon starting the free game, the upper image display panel 33 displays a free-game-number display image 90a indicative of the number of times in executing the free games. In this case, the upper image display panel 33 displays the free-game-number display image 90a of “10 FREE GAMES” indicating that the number of times in executing the free games is determined to be 10 times.

As shown in FIG. 6B, upon becoming the predetermined progressive value during the free game, in the first display region 70 of the symbol matrix SM, the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM. The “combined symbol 129” is a symbol image of which the horizontal or vertical direction is reduced so that at least two symbol images are displayed in an element of the symbol matrix SM, in which a single symbol is displayed. The two symbol images are combined with each other on condition that the side-BET is input. In this case, since the side-BET is input during the basic game, a combination formed of two “combined symbols 129” and one “sub character 122” is rearranged. In the “combined symbol 129”, the horizontal direction of the symbols of the main character 121 and the sub character 122 or jackpot symbol is reduced. In the second display region 71, the symbols, “main character 121”, “sub character 122”, “office building 123”, “gold bullion 124”, “car 125”, “stock certificate 126”, “jet 127”, and “villa 128” are rearranged in any of the elements of the symbol matrix SM.

As shown in FIG. 6C, in the “combined symbol 129” rearranged in the first display region 70 in FIG. 5B, area ratios of the respective symbols of the combined symbol are changed according to the number of times in executing the basic games. In this case, according to the number of times in executing the basic games, a scaling ratio in a horizontal direction between the main character 121 and the sub character 122 or jackpot symbol is changed so that the symbol of the main character 121 added to the “combined symbol 129” is rearranged more widely or the symbol of the sub character 122 or jackpot symbol is rearranged more widely. In this way, the “combined symbol 129” is changed. Thereafter, according to types of the combination of the changed “combined symbols 129” rearranged in the first display region 70 and the single symbol rearranged in the second display region 71, one bonus game is selectively executed from among a plurality of bonus games. In this case, since a combination of three sub characters 122 is rearranged, the jackpot bonus game is selected and executed according to the types of the combination.

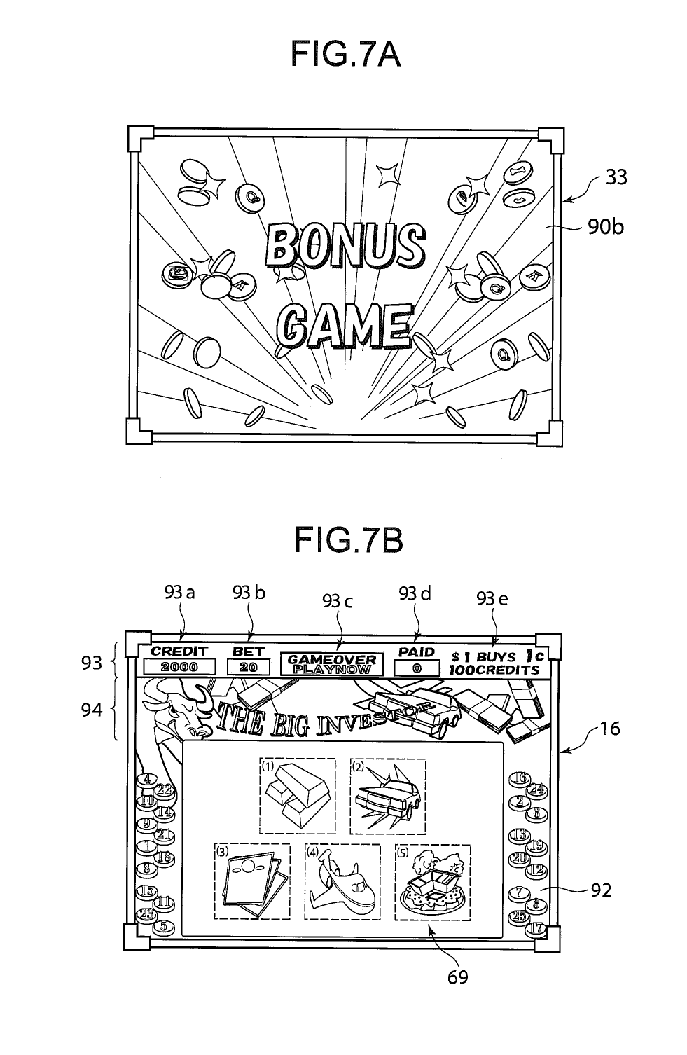

FIG. 7A to FIG. 9B are diagrams each illustrating an exemplary image displayed in the slot machine 10 according to the first embodiment shown in FIG. 2 during the jackpot bonus game. As shown in FIG. 7A, when the symbols rearranged in the elements of the symbol matrix SM in FIGS. 5B and 6C form a combination for executing the jackpot bonus game, the jackpot bonus game is started. Upon judging the start of the jackpot bonus game, the upper image display panel 33 displays a jackpot bonus game display image 90b indicative of the start of the jackpot bonus game. In this case, the upper image display panel 33 displays the jackpot bonus game display image 90b which is “BONUS GAME” indicative of the fact that the jackpot bonus game has been started.

As shown in FIG. 7B, upon starting the jackpot bonus game, the display region 92 displays a selection screen for determining types of jackpot bonus games. In this case, the display region 92 displays symbols of (1) to (5) made up of “gold bullion 124”, “car 125”, “stock certificate 126”, “jet 127”, and “villa 128”. These symbols are displayed so that the types of the jackpot bonus games can be selected through the selection of the symbols by the touch panel 69.

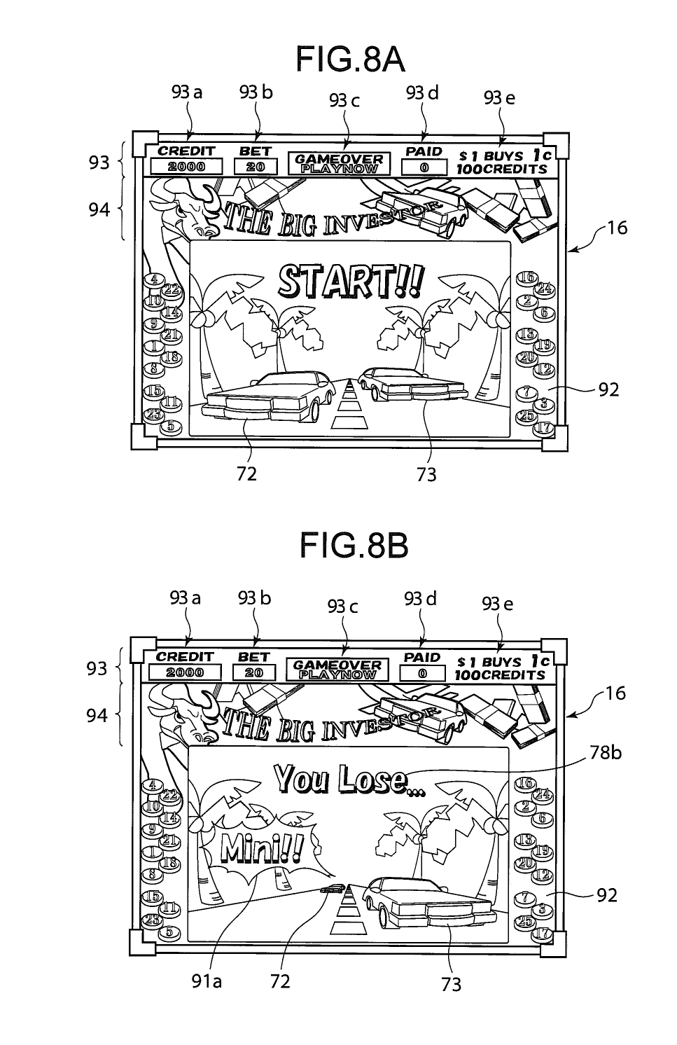

FIGS. 8A and 8B are diagrams each illustrating an exemplary image displayed in the slot machine 10 according to the first embodiment shown in FIG. 2, during the jackpot bonus game. As shown in FIG. 8A, the jackpot bonus game corresponding to the symbol selected in FIG. 7B is displayed. In this case, since the symbol (2) is selected in FIG. 7B, the jackpot bonus game of a car race is started, and a car-race start screen is displayed which constitutes the main character effect image 72 and the sub character effect image 73.

As shown in FIG. 8B, a win-or-loss screen of the jackpot bonus game corresponding to the symbol selected in FIG. 7B is displayed. In this case, when the symbol (2) is selected in FIG. 7B and the sub character effect image 73 wins in the jackpot bonus game of a car race, a win-or-loss information display 78b of “You Lose” is displayed. A payout display image 91a of “Mini” indicative of types of payouts of the jackpot is displayed, and the payout corresponding to “Mini” is awarded.

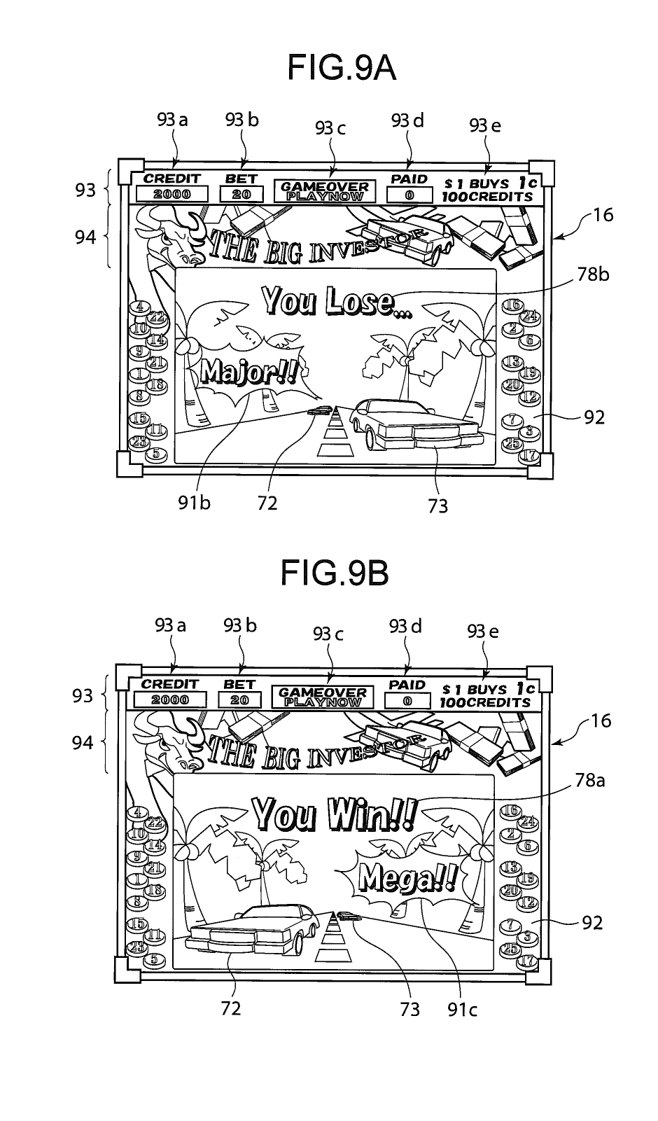

FIGS. 9A and 9B are diagrams each illustrating an exemplary image displayed in the slot machine 10 according to the first embodiment shown in FIG. 2, during the jackpot bonus game. As shown in FIG. 9A, when the symbol (2) is selected in FIG. 7B and the main character effect image 72 wins in the jackpot bonus game of a car race, a subsequent jackpot bonus game is started. In this case, the jackpot bonus game of a car race is started, and when the sub character effect image 73 wins, a win-or-loss information display 78b of “You Lose” is displayed. Further, a payout display image 91b of “Major” indicative of types of payouts of the jackpot is displayed, and a payout corresponding to “Major” is awarded.

As shown in FIG. 9B, when the symbol (2) is selected in FIG. 7B and the main character effect image 72 wins in the jackpot bonus game of a car race, a subsequent jackpot bonus game is started. In this case, the jackpot bonus game of a car race is started, and when the main character effect image 72 wins, the win-or-loss information display 78a of “You Win” is displayed. Further, a payout display image 91c of “Mega” indicative of types of payouts of the jackpot is displayed, and a payout corresponding to “Mega” is awarded.

Next, a process executed in the slot machine 10 according to the first embodiment will be described in detail with reference to the drawings. The main CPU 41 controls the progress of a game by reading out and executing the game program.

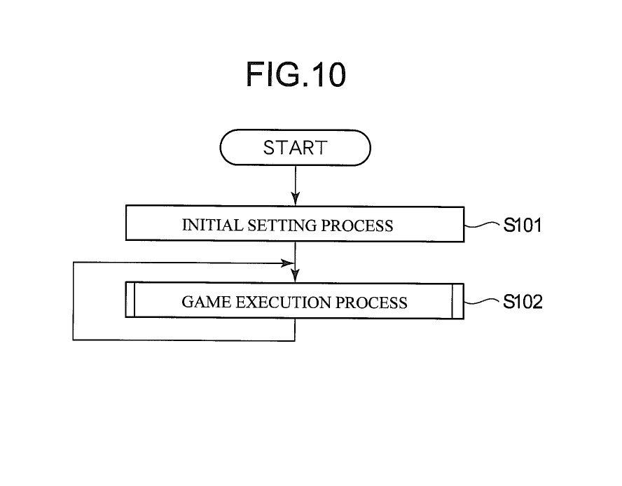

FIG. 10 is a flowchart showing a subroutine of the main process. In the main process, first, when a power switch is turned on (that is, when power is supplied), a mother board 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. The main CPU 41 writes game programs or the like from the ROM 42 into the RAM 43, and retrieves data for setting a payout ratio and country-identification information. The main CPU 41 also performs an authentication process for each program during execution of the initial setting process.

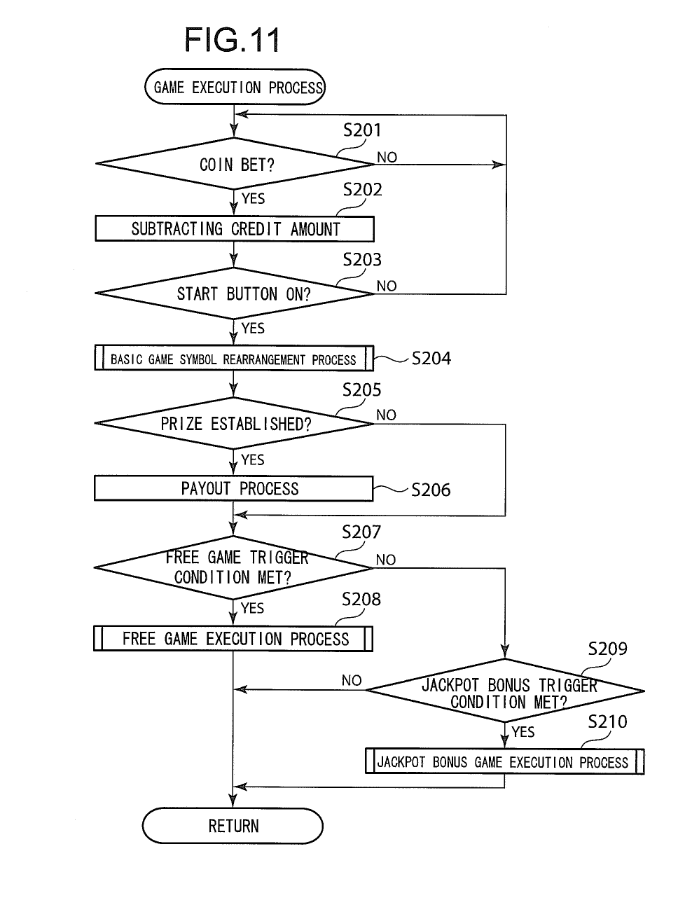

Next, the main CPU 41 performs a game execution process described later with reference to FIG. 11 (step S102). In this game execution process, the main CPU 41 sequentially reads and executes the game programs or the like from the ROM 42. By performing this game execution process, the slot machine 10 according to the first embodiment 10 executes the game. The game execution process is repeatedly performed while power is supplied to the slot machine 10.

FIG. 11 is a flowchart showing a subroutine of the game execution process invoked and performed at step S102 of the subroutine shown in FIG. 10 according to the first embodiment. First, the main CPU 41 judges whether a coin has been bet or not (step S201). Specifically, the main CPU 41 judges whether or not an input signal has been received. The input signal is output from the 1-BET switch 26S at the time of operation of the 1-BET button 26 or is output from the MAX-BET switch 27S at the time of operation of the MAX-BET button. The main CPU 41 controls the current step to return to the process at step S201 upon judging that no coin has been bet (step S201: NO).

On the other hand, the main CPU 41 subtracts the number of bet coins from the credit amount stored in the RAM 43 (step S202) upon judging that a coin has been bet (step S201: YES). Where the number of bet coins is larger than the credit amount stored in the RAM 43, the main CPU 41 controls the current step to return to step S201 without performing the process for subtracting the number of bet coins from the credit number stored in the RAM 43. Where the number of bet coins exceeds the upper limit (50 coins in this embodiment) of coins that can be bet in one game, the main CPU 41 controls the step to return to step S203 without performing the process for subtracting the number of bet coins from the credit number stored in the RAM 43.

At step S203, the main CPU 41 judges whether or not the start button 23 has been set to ON (step S203). Specifically, the main CPU 41 judges whether or not an input signal output from the start switch 23S when the start button 23 is pressed has been received. The main CPU 41 controls the step to return to step S201 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

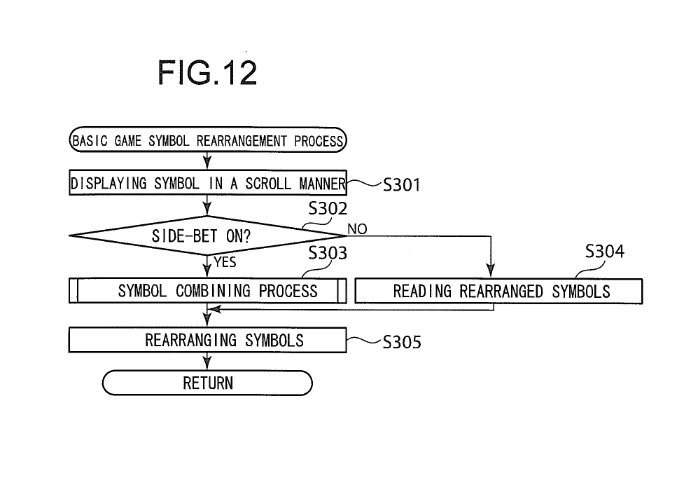

On the other hand, the main CPU 41 performs a symbol rearrangement process (step S204) described later with reference to FIG. 12 upon judging that the start button 23 has been set to ON (step S203: YES). Specifically, the main CPU 41 executes the program stored in the RAM 43 and determines the symbols to be rearranged in elements of the symbol matrix SM displayed on the lower image display panel 16. The symbols are selected from among the symbols, “main character 121”, “sub character 122”, “office building 123”, “gold bullion 124”, “car 125”, “stock certificate 126”, “jet 127”, “villa 128”, and “combined symbol 129”. This determination is based on the symbol weighing data and random numeric values sampled by sampling the random numeric values in a numeric-value range which comes under a predetermined range of random numeric values. The main CPU 41 then rearranges the symbols in the elements of the symbol matrix SM.

Next, the main CPU 41 judges whether a prize has been established or not (step S205). Specifically, the main CPU 41 judges whether or not the number of symbols of respective types rearranged in the elements of the symbol matrix SM is a winning number allowed to award any of payouts. Herein, the prize is established on condition that a predetermined number of symbols of the same type are rearranged in the elements of the symbol matrix SM.

Upon judging that the prize is established (step S205: YES), the main CPU 41 then performs a coin-payout process in accordance with the amount of bet and the number of coins set for the winning number (step S206). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

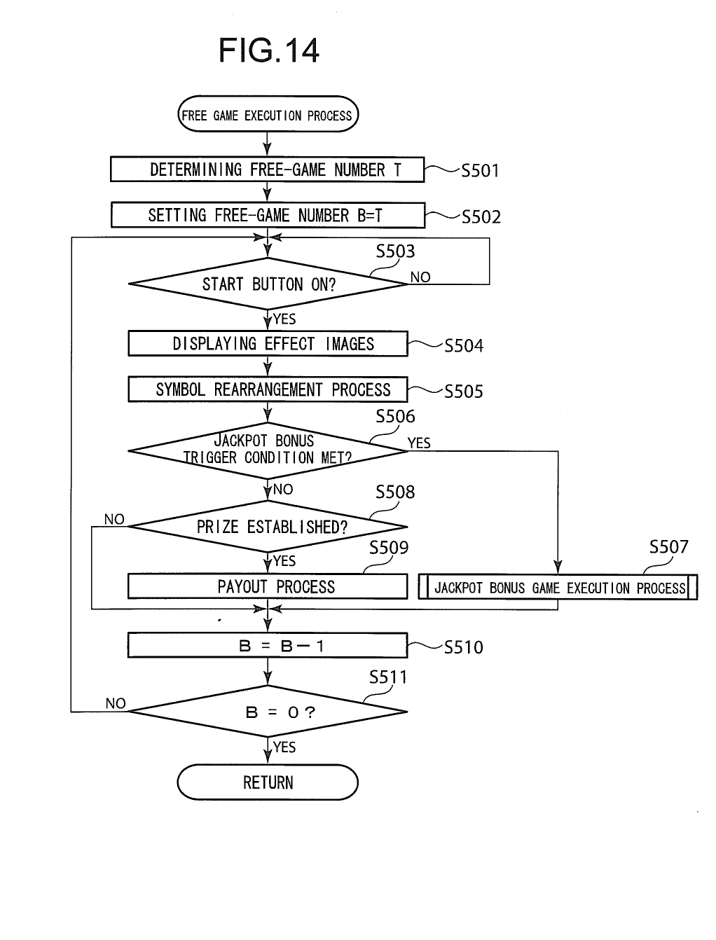

Meanwhile, the main CPU 41 judges whether or not a free game trigger condition has been met (step S207) upon judging that the prize is not established (step S205: NO) or upon executing the process at step S206. Specifically, the main CPU 41 executes the program stored in the RAM 43 to sample the random numeric values in a numeric-value range which comes under a predetermined range of random numeric values, thereby judging whether or not the free game trigger condition has been met based on the sampled random numeric values. Upon judging that the free game trigger condition has been met (step S207: YES), the main CPU 41 performs a free-game execution process described later with reference to FIG. 14 (step S208). In this free-game execution process, the main CPU 41 sequentially reads and executes the game programs or the like from the ROM 42 and performs the free-game execution process.

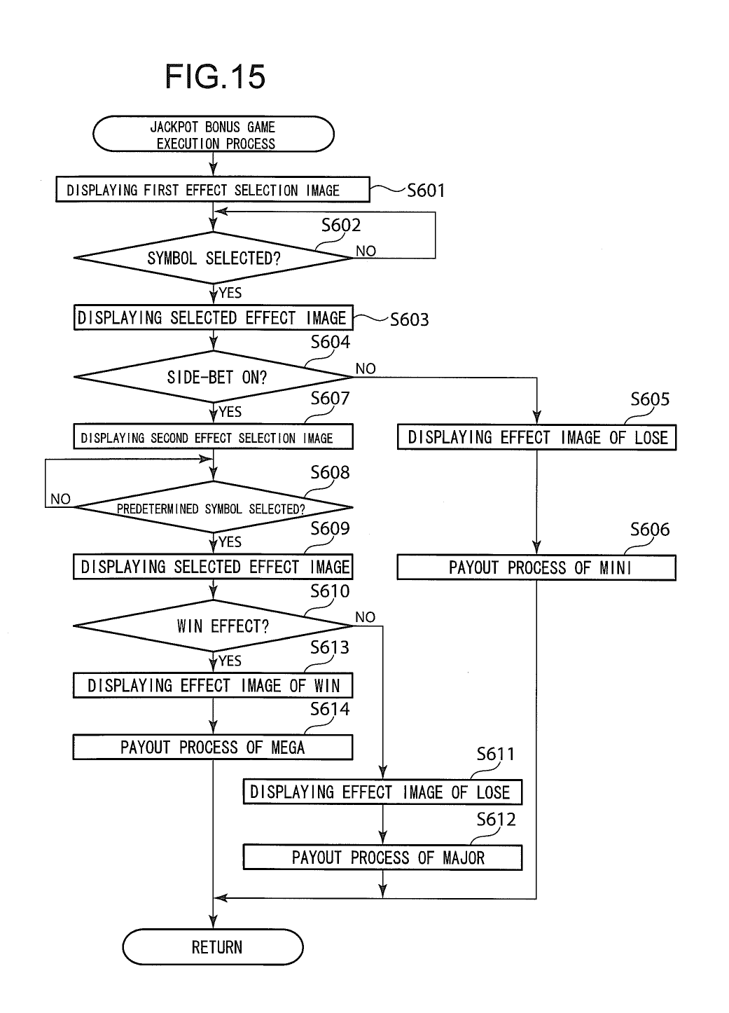

Meanwhile, the main CPU 41 judges whether or not a jackpot bonus game trigger condition has been met (step S209) when judging that the free game trigger condition is not met (step S207: NO). Specifically, the main CPU 41 executes the program stored in the RAM 43 to sample the random numeric values in a numeric-value range which comes under a predetermined range of random numeric values, thereby judging whether or not the jackpot bonus game trigger condition has been met based on the sampled random numeric values. Upon judging that the jackpot bonus game trigger condition is met (step S209), the main CPU 41 performs a jackpot bonus game execution process described later with reference to FIG. 15 (step S210). In this jackpot bonus game, the main CPU 41 sequentially reads and executes the game programs or the like from the ROM 42 and performs the jackpot bonus game execution process.

On the other hand, the CPU 41 terminates the game execution process when judging that the jackpot bonus game trigger condition is not met (step S209: NO) or when executing the process at step S208.

FIG. 12 is a flowchart showing a subroutine of the basic symbol rearrangement process invoked and performed at step S204 of the subroutine shown in FIG. 11. First, the main CPU 41 displays the symbols in a scrolling manner (step S301). Specifically, the main CPU 41 successively displays in a scrolling manner the symbols that are rearranged in the elements of the symbol matrix SM displayed on the lower image display panel.

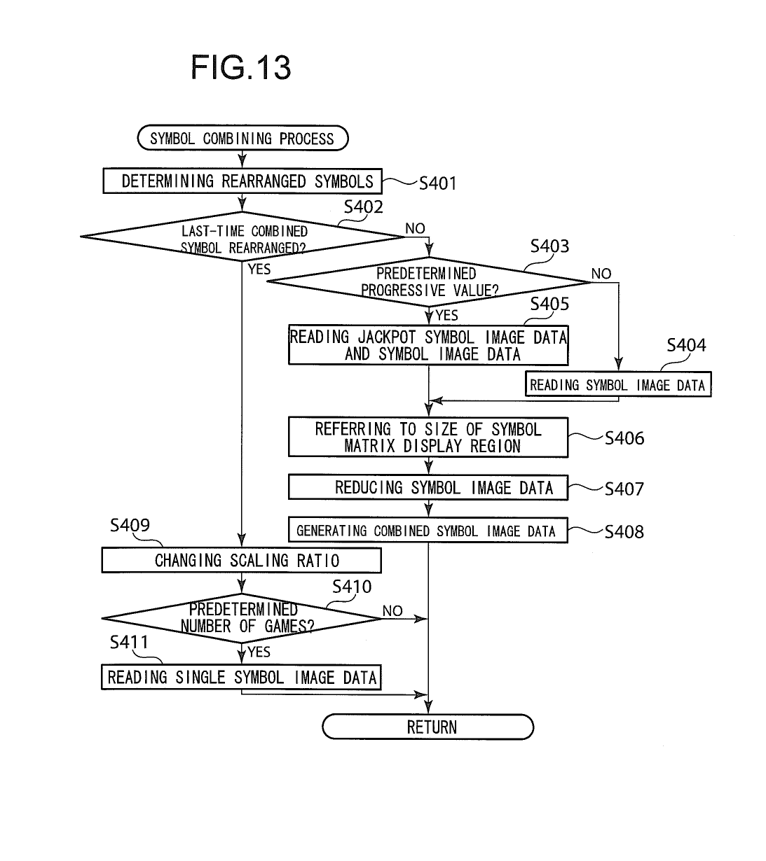

Next, the main CPU 41 judges whether or not a side-BET has been set to ON (step S302). Specifically, the main CPU 41 judges whether or not an input signal has been received, the signal being output from a side-BET switch 85S when the side-BET button 85 is pushed. Upon judging that the side-BET button 85 has been set to ON (step S302: YES), the main CPU 41 executes a symbol combining process described later with reference to FIG. 13 (step S303). Specifically, the main CPU 41 reads at least two symbol image data including the symbol image data that have been combined on condition of an input of the side-BET, and reduces a horizontal or vertical direction of the symbol image data so as to be displayed in the region for displaying the single symbol. In this way, the combined symbol is rearranged.

On the other hand, upon judging that the side-BET has not been set to ON (step S302: NO), the main CPU 41 reads the rearranged symbol (step S304). Specifically, the main CPU 41 selects a storage area, provided in the RAM 43, of predetermined symbol data. Upon terminating this process, the main CPU 41 controls the step to move to step S305.

Next, upon terminating the process at step S303 or step S304, the main CPU 41 rearranges the symbols (step S305). Specifically, the main CPU 41 executes the program stored in the RAM 43 and determines the respective symbols to be arranged, which are judged at step S303 or step S304, in the elements of the symbol matrix SM displayed on the lower image display panel. The symbols are selected from among the symbols “main character 121”, “sub character 122”, “office building 123”, “gold bullion 124”, “car 125”, “stock certificate 126”, “jet 127”, “villa 128”, and “combined symbol 129”, of which the last symbol is combined at step S303. This determination is based on the symbol weighing data and random numeric values sampled by sampling the random numeric values in a numeric-value range which comes under a predetermined range of random numeric values. The main CPU 41 then rearranges the symbols in the elements of the symbol matrix SM. Upon execution of this process, the main CPU 41 terminates the basic game symbol rearrangement process.

FIG. 13 is a flowchart showing a subroutine of the symbol combining process invoked and performed at step S303 of the subroutine shown in FIG. 12. First, the main CPU 41 judges the rearranged symbols (step S401). Specifically, the main CPU 41 selects the storage area, provided in the RAM 43, of predetermined symbol data.

Next, the main CPU 41 judges whether or not the combined symbol is rearranged last time (step S402). Specifically, the main CPU 41 judges whether or not the “combined symbol 129” is rearranged in the first display region 70 of the symbol matrix SM during the last basic game. Upon judging that the combined symbol is not rearranged last time (step S402: NO), the main CPU 41 judges whether or not the predetermined progressive value (step S403) is obtained. Specifically, the main CPU 41 judges whether or not the value regarding the credit of the progressive jackpot is a predetermined value. Upon judging that the value is not the predetermined progressive value (step S403: NO), the main CPU 41 reads the symbol image data (step S404). Specifically, from among the symbol image data stored in the RAM 43, the main CPU 41 reads two symbol image data that are combined with each other. Upon terminating this process, the main CPU 41 controls the step to move to step S406.

On the other hand, upon judging that the value is the predetermined progressive value (step S402: YES), the main CPU 41 reads the jackpot symbol image data and the symbol image data (step S405). Specifically, from among the image data stored in the RAM 43, the main CPU 41 reads the two items of image data, i.e., the image data of the jack pot symbol and that of the symbol to which the jackpot symbol is added.

Next, the main CPU 41 refers to a size of the symbol matrix display region (step S406). Specifically, the main CPU 41 refers to a size of the element of the display region of the symbol matrix SM in which the combined symbol is rearranged.

Next, the main CPU 41 reduces the symbol image data (step S407). Specifically, the main CPU 41 reduces a horizontal or vertical direction of the symbol image data read to match the size referred at step S406 so that the two symbol images read at step S405 are displayed in the region for displaying a single symbol.

Next, the main CPU 41 generates the combined symbol image data (step S408). Specifically, based on the symbol image data reduced at step S407, the main CPU 41 generates the combined symbol image data for rearranging the combined symbol in the first display region 70 of the symbol matrix SM (see FIG. 1A).

On the other hand, upon judging that the combined symbol is rearranged last time (step S402: YES), the main CPU 41 changes a scaling ratio (step S409). Specifically, the main CPU 41 changes the scaling ratio of the symbol image data so that the area ratios of the respective image data of the combined symbol change according to the number of times in executing the basic games (see FIG. 1B).

Next, the main CPU 41 judges whether or not a predetermined number of games is reached (step S410). Specifically, the main CPU 41 judges whether or not the predetermined number of basic games is reached from a time when the combined symbol is rearranged. Upon judging that the predetermined number of games is not reached (step S410: NO), the main CPU 41 terminates the symbol combining process.

On the other hand, upon judging that the predetermined number of games is reached (step S410: YES), the main CPU 41 reads the single symbol image data (step S411). Specifically, the main CPU 41 judges whether or not the predetermined number of games is reached from a time when the combined symbol is rearranged. Upon judging that the predetermined number of games is not reached (step S410: NO), the main CPU 41 terminates the symbol combining process.

On the other hand, upon judging that the predetermined number of games is reached (step S410: YES), the main CPU 41 reads the single symbol image data (step S411). Specifically, in order to transform the combined symbol into the single symbols by gradually changing the area ratio of the respective symbols of the combined symbol according to the number of times in executing the basic games at step S409, the main CPU 41 reads the single symbol, based on the combined symbol (see FIG. 1C). Upon terminating the process at step S411, the main CPU 41 terminates the symbol combining process.

FIG. 14 is a flowchart showing a subroutine of the free-game execution process invoked and executed at step S208 of the subroutine shown in FIG. 11. First, the main CPU 41 determines the free-game number T (step S501). Specifically, the main CPU 41 determines the free-game number T in accordance with the program stored in the RAM 43.

Next, the main CPU 41 performs a process for setting the free-game number B=T (step S502). Specifically, the main CPU 41 sets a remaining free-game number B=T in a storage area, provided in the RAM 43, of data indicative of the remaining free-game number B=T. T is the free-game number determined at step S401.

Next, the main CPU 41 judges whether or not the start button 23 has been set to ON (step S503). Specifically, the main CPU 41 judges whether or not an input signal output from the start switch 23S when the start button 23 is pushed has been received. The main CPU 41 controls the step to return to step S403 upon judging that the start button 23 has not been set to ON (step S503: NO).

On the other hand, upon judging that the start button 23 has been set to ON (step S503: YES), the main CPU 41 performs a process for displaying the effect image (step S504). Specifically, the main CPU 41 displays the free-game-number display image 90a corresponding to the number of times in executing the free game on the upper image display panel 33 (see FIG. 6A).

Next, the main CPU 41 performs a process for rearranging symbols in the free game (step S505). Specifically, the main CPU 41 executes the program stored in the RAM 43 and determines the symbols to be rearranged in elements of the symbol matrix SM 28 displayed on the lower image display panel. These symbols are selected from among the symbols, “main character 121”, “sub character 122”, “office building 123”, “gold bullion 124”, “car 125”, “stock certificate 126”, “jet 127”, “villa 128”, and “combined symbol 129”. This determination is based on the symbol weighing data and random numeric values sampled by sampling the random numeric values in a numeric-value range which comes under a predetermined range of random numeric values. The main CPU 41 then rearranges the symbols to be rearranged in the elements of the symbol matrix SM.

Next, the main CPU 41 judges whether a jackpot bonus trigger condition has been met or not (step S506). Specifically, the main CPU 41 executes the program stored in the RAM 43 to sample the random numeric values in a numeric-value range which comes under a predetermined range of random numeric values, thereby judging whether or not the jackpot bonus game trigger condition has been met based on the sampled random numeric values. The main CPU 41 controls the step to move to step S508 upon judging that the jackpot bonus game trigger condition has been met (step S506: NO).

On the other hand, upon judging that the jackpot bonus trigger condition has been met (step S506: YES), the main CPU 41 executes a jackpot bonus game execution process described later with reference to FIG. 15 (step S507). In this jackpot bonus game, the main CPU 41 sequentially reads and executes the game programs or the like from the ROM 42 and performs the jackpot bonus game execution process.

Next, the main CPU 41 judges whether a prize has been established or not (step S508). Specifically, the main CPU 41 judges whether or not the number of symbols of respective types rearranged in the elements of the symbol matrix SM is a winning number allowed to award any of payouts. Herein, the prize is established on condition that a predetermined number of symbols of the same type are rearranged in the elements of the symbol matrix SM.

Thereafter, upon judging that the prize has been established (step S508: YES), the main CPU 41 performs a payout process for paying out the coins in accordance with the number of coins set for the winning number (step S509). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

On the other hand, upon judging that the prize has not been established (step S508: NO) or upon executing the processes at step S509, the main CPU 41 sets the remaining free-game number B=B−1 (step S510). Specifically, the main CPU 41 sets B=B−1 at a value of the remaining free-game number B stored in the RAM 43.

The main CPU 41 then judges whether or not a value of the remaining free-game number B is equal to zero (step S511). Specifically, the main CPU 41 judges whether or not a value of the remaining free-game number B stored in the RAM 43 is equal to zero. Upon judging that the value of the remaining free-game number B is not zero (step S511: NO), the main CPU 41 controls the step to return to step S503.

On the other hand, upon judging that the value of B is equal to zero (step S511: YES), the main CPU 41 terminates the free-game execution process.

FIG. 15 is a flowchart showing a subroutine of the jackpot bonus game execution process invoked and performed at step S210 of the subroutine shown in FIG. 11 and at step S507 of the subroutine shown in FIG. 14. At first, the main CPU 41 displays a first effect selection image (step S601). Specifically, the main CPU 41 displays the jackpot bonus game display image 90b displaying the start of the jackpot bonus game on the upper image display panel 33, and a selection screen for determining the types of jackpot bonus games in the display region 92 (see FIG. 7B).

Next, the main CPU 41 judges whether or not the symbol is selected (step S602). Specifically, the main CPU 41 judges whether or not the symbol displayed on the selection screen for determining the types of jackpot bonus games is selected via the touch panel 69. Upon judging that the symbol is not selected (step S602: NO), the main CPU 41 controls the step to return to step S502.

On the other hand, upon judging that the symbol is selected (step S602: YES), the main CPU 41 displays the selected effect image (step S603). Specifically, the main CPU 41 sequentially reads the effect image corresponding to the symbol selected at step S502 from the ROM 42 and displays the effect image in the display region 92 (see FIG. 8A).

Next, the main CPU 41 judges whether or not the side-BET has been set to ON (step S604). Specifically, the main CPU 41 judges whether or not an input signal has been received, the signal being output from the side-BET switch 85S when the side-BET button 85 is pushed. Upon judging that the side-BET button 85 has not been set to ON (step S604: NO), the main CPU 41 displays an effect images of “Lose” (step S605). Specifically, the CPU 41 reads the effect image corresponding to the effect image of “Lose” from the ROM 42, and displays the effect image in the display region 92 (see FIG. 8B). Next, the main CPU 41 executes a payout process of Mini (step S606). Specifically, the main CPU 41 performs the coin payout process corresponding to “Mini”. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. Upon execution of the process at step S606, the main CPU 41 terminates the jackpot bonus game execution process.

On the other hand, upon judging that the side-BET has been set to ON (step S604: YES), the main CPU 41 displays an effect image of Win and displays a second effect selection image (step S607). Specifically, the main CPU 41 displays in the display region 92 a selection screen for determining the types of jackpot bonus games so that the symbol selected at step S602 is identifiable.

Next, the main CPU 41 judges whether or not the predetermined symbol is selected (step S608). Specifically, the main CPU 41 judges whether or not the symbol other than that selected at step S602 is selected by way of the symbol touch panel 69. Upon judging that the predetermined symbol is not selected (step S608: NO), the main CPU 41 controls the step to return to step S608.

On the other hand, upon judging that the predetermined symbol is selected (step S608: YES), the main CPU 41 displays the selected effect image (step S609). Specifically, the main CPU 41 sequentially reads the effect image corresponding to the symbol selected at step S602, from the ROM 42, and displays the effect image in the display region 92.

Next, the main CPU 41 judges whether or not the “Win” effect is read (step S610). Specifically, the main CPU 41 judges whether or not the effect image read at step S609 is the “Win” effect. Upon judging that the Win effect is not read (step S610: NO), the main CPU 41 displays the effect image of “Lose” (step S611). Specifically, the main CPU 41 reads the effect image corresponding to the effect image of “Lose” from the ROM 42 and displays the effect image in the display region 92 (see FIG. 9A). Next, the main CPU 41 executes a payout process of “Major” (step S612). Specifically, the main CPU 41 performs the coin payout process corresponding to “Major”. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. Upon execution of the process at step S612, the main CPU 41 terminates the jackpot bonus game execution process.

On the other hand, upon judging that the Win effect is read (step S610: YES), the main CPU 41 displays the effect image of “Win”. Specifically, the main CPU 41 reads the effect image corresponding to the effect image of “Win” from the ROM 42 and displays the effect image in the display region 92 (see FIG. 9B). Next, the main CPU 41 executes a payout process of “Mega” (step S614). Specifically, the main CPU 41 performs the coin-payout process corresponding to “Mega”. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. Upon execution of the process at step S614, the main CPU 41 terminates the jackpot bonus game execution process.

Next, a slot machine 100 according to a second embodiment will be described with reference to the drawings. The slot machine according to the second embodiment described below is a so-called hybrid slot machine in which a plurality of rotatably-supported mechanical reels have a transparent liquid crystal panel on front surfaces to display images of various symbols drawn on peripheral surfaces of the mechanism reels through the transparent liquid crystal panel through which the pictures are allowed to pass. The slot machine according to the second embodiment has an appearance, circuitry, and the like that are substantially the same as those of the slot machine 10 according to the first embodiment. Thus, a duplicated explanation is omitted here. Constituent elements corresponding to those of the slot machine 10 are designated by the same reference numerals and are explained.

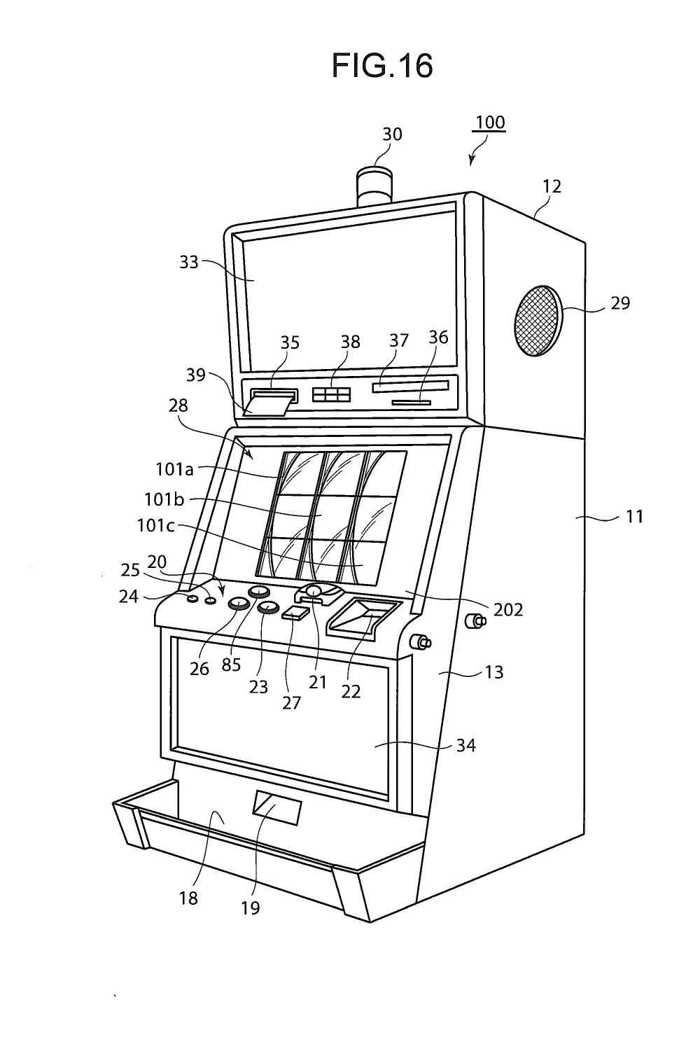

FIG. 16 is a view schematically showing an appearance of a frame format of the slot machine according to the second embodiment of the present invention. As shown in FIG. 16, the slot machine 100 is rotatably provided with three reels 101a to 101c. A symbol column made up of the symbols, “main character 121”, “sub character 122”, “office building 123”, “gold bullion 124”, “car 125”, “stock certificate 126”, “jet 127”, and “villa 128” is drawn on the respective one of the outer circumferential surfaces of the reels 101a to 101c.

A main liquid crystal panel 202 formed of a transparent liquid crystal panel, which is disposed at the main door, is provided in front of the respective reels 101a to 101c. The main liquid crystal panel 202 displays the symbol display region 28 with visually recognizable rear surface so as to surround symbols which were drawn on the reels 101a to 101c and displayed in a stopped state, respectively. The symbols drawn on the reels 101a to 101c are visualized by rendering the symbol display region 28 transparent.

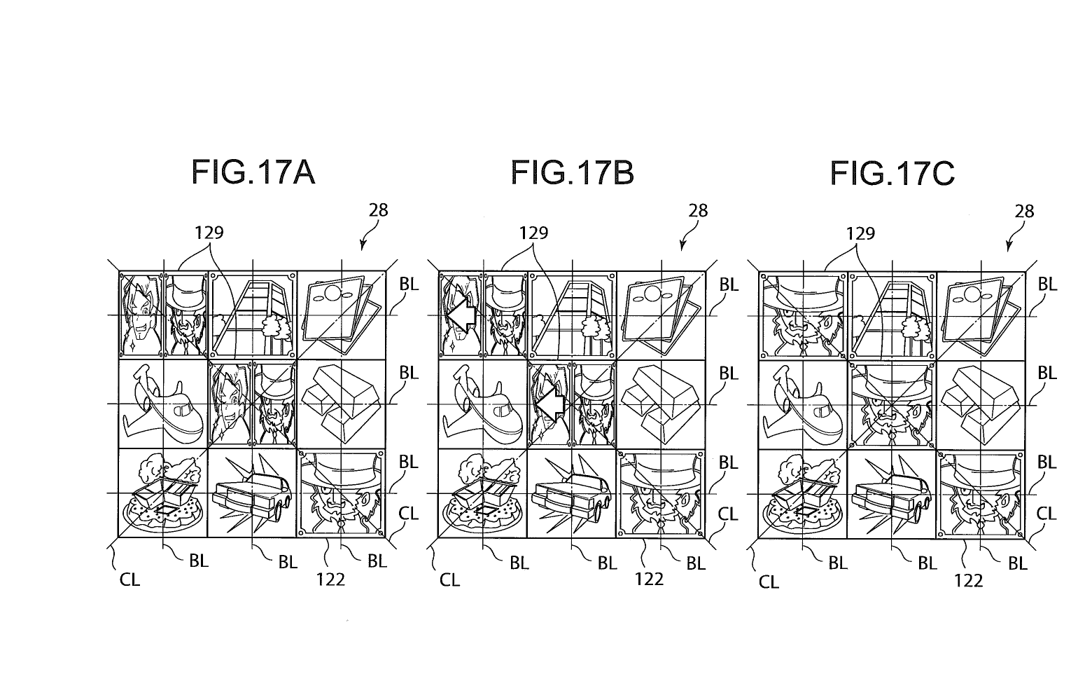

FIGS. 17A, 17B, and 17C are views each showing an exemplary symbol matrix during a basic game. As shown in FIGS. 17A to 17C, the symbol display region 28 is displayed on the main liquid crystal panel 202 provided in the slot machine 100 of the present invention. A total of three reels 101a to 101c are rotatably provided rearwardly of the liquid crystal panel 202. Six basic lines BL are set along each row or each column in the symbol display region 28. In the embodiment of the present invention, the basic line means a wining line other than a cross line. Two cross lines CL are set which diagonally cross the symbol display region 28. Eight winning lines in the embodiment of the present invention include the basic lines BL and the cross lines CL. When a predetermined symbol is rearranged on the bet winning line, a LIN payment is awarded based on a winning combination, and then, an ANY payment is awarded according to the number of symbols rearranged in the symbol display region 28.

As shown in FIG. 17A, when the reels 101a to 101c stop, any of a total of nine symbols in three rows and three columns, “main character 121”, “sub character 122”, “office building 123”, “gold bullion 124”, “car 125”, “stock certificate 126”, “jet 127”, and “villa 128”, are displayed in a stopped state. When a predetermined trigger condition is met, with the use of the liquid crystal panel 202, the “combined symbol 129”, in which at least two symbol images combined on condition that the side-BET is input are used to display a single symbol, is rearranged to be superposed on the reels 101a and 101b. In this case, after the reels 101a and 101b are displayed in a stopped state, the “combined symbols 129” are rearranged to be superposed with the use of the liquid crystal panel 202 in display windows 103a and 103e. Thereafter, the reel 101c is displayed in a stopped state, and the “sub character 122” is rearranged.

As shown in FIG. 17B, area ratios of the respective symbols of the combined symbol, i.e., the “combined symbol 129” displayed on the liquid crystal panel 202 within the symbol display region 28 on the lower image display panel 16 in FIG. 17A are changed during a predetermined basic game according to the number of times in executing the basic games. In this case, according to the number of times in executing the basic games, a scaling ratio in a horizontal direction between the main character 121 and the sub character 122 or jackpot symbol is changed so that the symbol of the main character 121 added to the “combined symbol 129” is rearranged more widely or the symbol of the sub character 122 or jackpot symbol is rearranged more widely. In this way, the “combined symbol 129” is changed.

As shown in FIG. 17C, the area ratios of the respective symbols of the combined symbol are changed in FIG. 1B. Thereafter, according to types of the combination of the changed “combined symbol 129” displayed on the liquid crystal panel 202 and the single symbol displayed in a stopped state in the symbol display region 28, one bonus game is selectively executed from among a plurality of bonus games. In this case, since a winning combination of three sub characters 122 is rearranged, the payment is awarded based on the winning combination. Then, according to types of the winning combination, the jackpot bonus game is selected and executed.

In the foregoing, while the embodiments of the present invention have been described, these embodiments merely present specific examples. An appropriate design change can be made for the specific configuration of each means or the like. Also, the effects described in the embodiments of the present invention are only listing the most preferable effects arising from the present invention, and the effects of the present invention are not limited to those described in the embodiments of the present invention.

What is claimed is:

1. A slot machine, comprising:
a display device for displaying a symbol matrix display region having a first display region and a second display region;
an input device for accepting an input of a normal BET and that of a side-BET different from the normal BET;
a memory for storing plural types of symbol image data; and
a controller for controlling the display device and the input device, the controller being programmed to:
(a) execute a basic game;
(b) read, from among the symbol image data stored in the memory, at least two symbol image data including symbol image data that may be combined with each other on condition that the side-BET is input, during the basic game,
reduce a horizontal or vertical direction of the read symbol image data so that said at least two symbol images are displayed in a region for displaying a single symbol, and
generate, based on the reduced symbol image data, combined symbol image data for displaying a combined symbol to be displayed in the first display region;
(c) rearrange the combined symbol combined corresponding to the combined symbol image data in the first display region within the symbol display region and rearrange symbols corresponding to the plural types of symbol image data in the second display region within the symbol display region, during the basic game;
(d) generate the combined symbol image data obtained by changing scaling ratios of the symbol image data so that area ratios of respective symbol images of the combined symbol are changed according to the number of times in executing the basic games, and
rearrange the combined symbol in the first display region according to the changed combined symbol image data; and
(e) selectively execute one bonus game from among a plurality of bonus games according to types of the combination, in a case where a combination of the combined symbol displayed in the first display region and the single symbols displayed in the second display region matches a predetermined combination.

2. The slot machine according to claim 1, wherein
the controller, in the itemized (d), gradually changes the area ratios of the respective symbol images of the combined symbol according to the number of times in executing the basic games to transform the combined symbol into the single symbols, thereby rearranging the single symbols based on the combined symbol in the first display region, and
the controller, in the itemized (e), selectively executes one bonus game from among a plurality of bonus games according to types of the combination, in a case where the single symbols transformed from the combined symbol displayed in the first display region and the single symbols displayed in the second display region matches a predetermined combination.

3. The slot machine according to claim 1, further comprising a memory for cumulatively storing a progressive value, wherein
the controller, in the itemized (b), reads the symbol image data from the memory with referring to the progressive value of the memory so that one jackpot symbol from among the plurality of jackpot symbols is added to the combined symbol in response to a jackpot becoming a predetermined progressive value.

4. A slot machine, comprising:
a display device for displaying a symbol matrix display region having a first display region and a second display region;
an input device for accepting an input of a normal BET and that of a side-BET different from the normal BET;
a memory for storing plural types of symbol image data; and
a controller for controlling the display device and the input device, the controller being programmed to:
(a) execute a basic game;
(b) read, from among the symbol image data stored in the memory, at least two symbol image data including symbol image data that may be combined with each other on condition that the side-BET is input, during the basic game,
reduce a horizontal or vertical direction of the read symbol image data so that said at least two symbol images are displayed in a region for displaying a single symbol, and
generate, based on the reduced symbol image data, combined symbol image data for displaying a combined symbol to be displayed in the first display region;
(c) rearrange the combined symbol combined corresponding to the combined symbol image data in the first display region within the symbol display region and rearrange symbols corresponding to the plural types of symbol image data in the second display region within the symbol display region, during the basic game;
(d) gradually change area ratios of respective symbol images of the combined symbol according to the number of times in executing the basic games to transform the combined symbol into the single symbols, thereby rearranging the single symbols based on the combined symbol in the first display region, and
(e) selectively execute one bonus game from among a plurality of bonus games according to types of the combination, in a case where a combination of the single symbols transformed from the combined symbol displayed in the first display region and the single symbols displayed in the second display region matches a predetermined combination.

5. The slot machine according to claim 4, further comprising a memory for cumulatively storing a progressive value, wherein
the controller, in the itemized (b), reads the symbol image data from the memory with referring to the progressive value of the memory so that one jackpot symbol from among the plurality of jackpot symbols is added to the combined symbol in response to a jackpot becoming a predetermined progressive value.

6. A slot machine, comprising:
a display device for displaying a symbol matrix display region having a first display region and a second display region;
an input device for accepting an input of a normal BET and that of a side-BET different from the normal BET;
a memory for storing plural types of symbol image data and for cumulatively storing a progressive value;
a controller for controlling the display device and the input device, the controller being programmed to:
(a) execute a basic game;
(b) read the symbol image data from the memory with referring to the progressive value of the memory so that one jackpot symbol from among the plurality of jackpot symbols is added in response to a jackpot becoming a predetermined progressive value, out of at least two symbol image data including the symbol image data that may be combined with each other on condition that the side-BET is input, from among the symbol image data stored in the memory, during the basic game,
reduce a horizontal or vertical direction of the read symbol image data so that said at least two symbol images are displayed in a region for displaying a single symbol, and
generate, based on the reduced symbol image data, combined symbol image data for displaying a combined symbol to be displayed in the first display region;
(c) rearrange the combined symbol combined corresponding to the combined symbol image data in the first display region within the symbol display region and rearrange symbols corresponding to the plural types of symbol image data in the second display region within the symbol display region, during the basic game;
(d) gradually change area ratios of respective symbol images of the combined symbol according to the number of times in executing the basic games to transform the combined symbol into the single symbols, thereby rearranging the single symbols based on the combined symbol in the first display region, and
(e) selectively execute one bonus game from among a plurality of bonus games according to types of the combination, in a case where a combination of the single symbols transformed from the combined symbol displayed in the first display region and the single symbols displayed in the second display region matches a predetermined combination.
